(19) United States
(12) Patent Application Publication
(10) Pub. No.: US 2015/0211565 A1
(43) Pub. Date: Jul. 30, 2015

(54) PLASTIC U-BASE FASTENER WITH NOISE CONTROL FEATURE

(71) Applicant: NEWFREY LLC, Newark, DE (US)

(72) Inventor: Steven M. Benedetti, Sterling Heights, MI (US)

(73) Assignee: NEWFREY LLC, Newark, DE (US)

(21) Appl. No.: 14/592,010

(22) Filed: Jan. 8, 2015

Related U.S. Application Data
(60) Provisional application No. 61/931,827, filed on Jan. 27, 2014.

(51) Int. Cl. F16B 19/00

(52) U.S. Cl. CPC F16B 19/004

(57) ABSTRACT

A fastener includes a first portion having first and second legs defining an upside-down A-shape. A second portion includes opposed first and second wings defining a V-shape. The first and second wings are individually initially integrally coupled to one of the legs by a frangible joint in an as-molded condition of the fastener. A frictionally coupled two-piece joined assembly of the first and second body portions is created when a force applied to the first portion drives the first portion into a cavity of the second portion between the first and second wings fracturing the frangible joint. The first portion is thereafter retained with the second portion by a first foot of the first leg and a second foot of the second leg oppositely positioned about and contacting a body end of the second portion, preventing rocking motion between the first and second portions.

### CROSS-REFERENCE TO RELATED APPLICATIONS

This application is a continuation that claims the benefit of U.S. Provisional Application No. 61/931,827 filed on Jan. 27, 2014. The entire disclosure of the above application is incorporated herein by reference.

### FIELD

The present disclosure relates to fasteners used to join trim components having blade elements to body panels of automotive vehicles.

### BACKGROUND

This section provides background information related to the present disclosure which is not necessarily prior art.

Fasteners are currently known for fastening panels, such as body panels and automobile interior trim pieces to a vehicle chassis. A body panel may be, for example, an interior or exterior body panel on an automobile vehicle, or any polymeric or other material interior trim component. The panel may also be an exterior body panel. The body panels are often required to attach to the chassis of the automobile vehicle with a low level of insertion force while yet providing for a high extraction force. Conventional fasteners used for this purpose do not also provide for the capability to eliminate a noise transmission path between the body panel and the trim component.

Further, known body panels when attached to the vehicle using known fasteners are not also capable of securing the panel to the chassis under the wide variety of environmental conditions necessary, including under vibration at various levels that also induce noise transmission. For example, the fastener device should prevent or minimize rattling or any other type of noise that may be audible to the occupants of the vehicle.

Known fasteners for attaching body panels to an automobile chassis may include one or more retaining tabs to permit a blade for example from a trim rib tower to be inserted. However, the fasteners do not fully isolate the blade from the body panel. Thus, known clip designs do not completely isolate vibration and noise sources between the vehicle body panel and the trim component.

### SUMMARY

This section provides a general summary of the disclosure, and is not a comprehensive disclosure of its full scope or all of its features.

According to several aspects, a fastener includes a first portion having first and second legs. A second portion having opposed first and second wings defines a V-shape. A frictionally coupled two-piece joined assembly of the first and second body portions is created when a force applied to the first portion drives the first portion into a cavity of the second portion between the first and second wings. The first portion is thereafter retained by contact between a first catch member of the first leg and a second catch member of the second leg extending into a window created in each of the first and second wings and directly contacting an edge of each window.

According to further aspects, a fastener includes a first portion having first and second legs defining an upside-down A-shape. A second portion includes opposed first and second wings defining a V-shape. The first and second wings are individually initially integrally coupled to one of the legs by a frangible joint in an as-molded condition of the fastener. A frictionally coupled two-piece joined assembly of the first and second body portions is created when a force applied to the first portion drives the first portion into a cavity of the second portion between the first and second wings fracturing the frangible joint. The first portion is thereafter retained with the second portion by a first foot of the first leg and a second foot of the second leg oppositely positioned about and contacting a body end of the second portion, preventing rocking motion between the first and second portions.

According to other aspects, a fastener system includes a fastener first portion having first and second legs defining an upside-down A-shape. A first flange is integrally connected to the first leg and a second flange is integrally connected to the second leg. A fastener second portion having opposed first and second wings defines a V-shape. A frictionally coupled two-piece joined assembly of the first and second body portions is created when a force applied to the first portion drives the first portion into a cavity of the second portion between the first and second wings. The first portion is thereafter retained by contact between a first catch member of the first leg and a second catch member of the second leg individually positioned in direct contact with an edge of a window created in each of the first and second wings. The two-piece joined assembly is adapted to be engaged in an aperture of a vehicle body panel, having the first and second flanges contacting a first surface of the body panel and the first and second wings contacting an oppositely facing second surface of the body panel such that when a trim component is connected by the two-piece joined assembly to the body panel a rib of the trim component is received between the first and second legs and a tower of the trim component contacts the first and second flanges preventing direct contact between the trim component and the body panel.

According to other aspects, a method for forming a fastener, includes the steps of: forming a fastener first portion having first and second legs defining an upside-down A-shape; simultaneously co-forming a fastener second portion having opposed first and second wings defining a V-shape; initially integrally coupling each one of the first and second wings to an individual one of the legs by a frangible joint defining an as-molded condition of the fastener; and applying a force to the first portion thereby fracturing the frangible joint; continuing application of the force to drive the first portion into the cavity of the second portion between the first and second wings; and retaining the first portion together with the second portion by positioning a first catch member of the first leg and a second catch member of the second leg individually in direct contact with an edge of a window created in each of the first and second wings to create a frictionally coupled two-piece joined assembly of the first and second body portions.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevational view of a fastener in an as-molded condition;

FIG. 2 is a side elevational view of the as-molded fastener of FIG. 1;

FIG. 3 is a top plan view of the fastener of FIG. 1;

FIG. 4 is a cross sectional front elevational view taken at section 4 of FIG. 3;

FIG. 5 is a left side perspective view of the fastener of FIG. 1;

FIG. 6 is a front elevational view of a fastener assembly created by fracturing frangible joints of the fastener of FIG. 1 and joining the two component parts;

FIG. 7 is a side elevational view of the fastener assembly of FIG. 6;

FIG. 8 is a front right perspective view of a rib tower of a trim component;

FIG. 9 is a partial cross sectional front elevational view of the fastener assembly of FIG. 6 after coupling to the rib tower of FIG. 8 and insertion into a vehicle body panel;

FIG. 10 is a front left perspective view of an alternate aspect fastener modified from the fastener of FIG. 1; and

FIG. 11 is a front left perspective view of the alternate aspect fastener assembly of FIG. 10 created by fracturing frangible joints of the fastener of FIG. 10 and joining the two component parts.

Corresponding reference numerals indicate corresponding parts throughout the several views of the drawings.

### DETAILED DESCRIPTION

Example embodiments will now be described more fully with reference to the accompanying drawings.

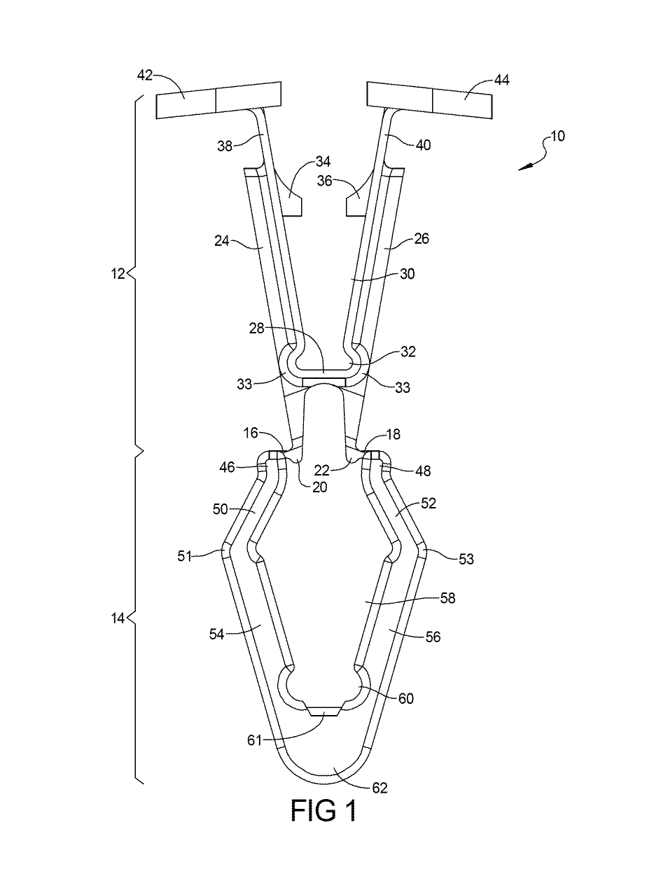

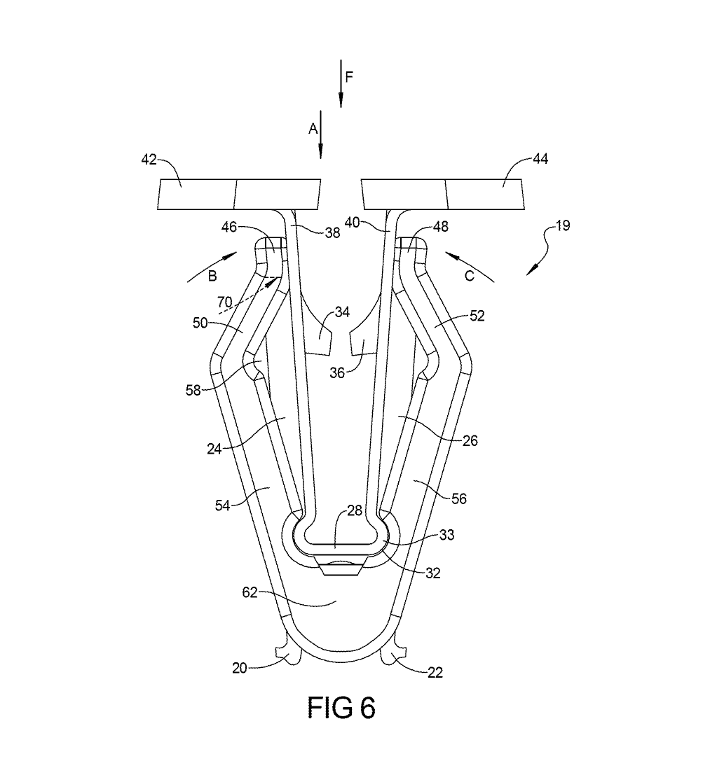

Referring to FIG. 1, a molded plastic material fastener 10 is initially molded as a one-piece assembly having fastener first and second portions 12, 14. Force applied to the first portion 12 of fastener 10 allows the first portion 12 to be inserted into the second portion 14 of the assembly by breaking two frangible joints 16, 18, thereby creating a frictionally coupled two-piece joined assembly 19 shown and described in greater detail in reference to FIG. 6. The two-piece joined assembly 19 is used in a vehicle by insertion into an aperture of a body panel of the vehicle as shown and described in greater detail in reference to FIG. 8. A component such as a trim piece having an integral rib tower molded therewith which is slidably inserted into the two-piece joined assembly, locking the trim piece to the body panel. Flanges of the two-piece joined assembly directly contact an upper surface of the body panel and the rib tower directly contacts the flanges to acoustically isolate the trim piece from the body panel.

With continuing reference to FIG. 1, fastener 10 used for the above joining assembly is made from a polymeric material which can be formed in an injection molding operation to provide the geometry shown. Fastener 10 includes first portion 12 initially (after molding) integrally connected to the second portion 14. First and second frangible joints 16, 18 initially integrally connect each of a first foot 20 and a second foot 22 of the first portion 12 (in the as-molded condition) to the second portion 14, thereby initially frangibly coupling the first portion 12 to the second portion 14. First portion 12 includes first and second legs 24, 26 which form an upside-down A-shape joined by a connecting bridge 28, thereby defining a cavity 30 having a double-rounded or oval shaped end 32. A partial oval-shaped raised member 33 is created at oval shaped end 32 which corresponds to the geometry of oval shaped end 32. Integrally connected to each of the first and second legs 24, 26 and extending into cavity 30 are each of a first raised member 34 and a second raised member 36. First and second raised members 34, 36 face other, but are not connected to each other. First and second connecting walls 38, 40 which can be thinner than the first and second legs 24, 26 to reduce component cost and weight integrally extend from ends of the first and second legs 24, 26. The first and second connecting walls 38, 40 support first and second flanges 42, 44 which are integrally connected to and are oriented approximately perpendicular to the first and second connecting walls 38, 40.

The second portion 14 includes oppositely directed first and second wings 46, 48 facing outwardly with respect to each other that are initially integrally connected by the first and second frangible joints 16, 18 to the first and second legs 24, 26. The second portion 14 further includes an outwardly tapering first tension leg 50 tapering outwardly to an apex 51, and an outwardly tapering second tension leg 52 tapers outwardly to an apex 53. From apexes 51, 53 first and second support legs 54, 56 extend downwardly and taper inwardly toward each other as viewed in FIG. 1 such that the first and second tension legs 50, 52 and the first and second support legs 54, 56 together create a diamond-shaped internal cavity 58. An oval-shaped cavity 60 is positioned at a lower end of the internal cavity 58 created by an end wall 61. The first and second support legs 54, 56 are integrally connected by a U-shaped body end 62.

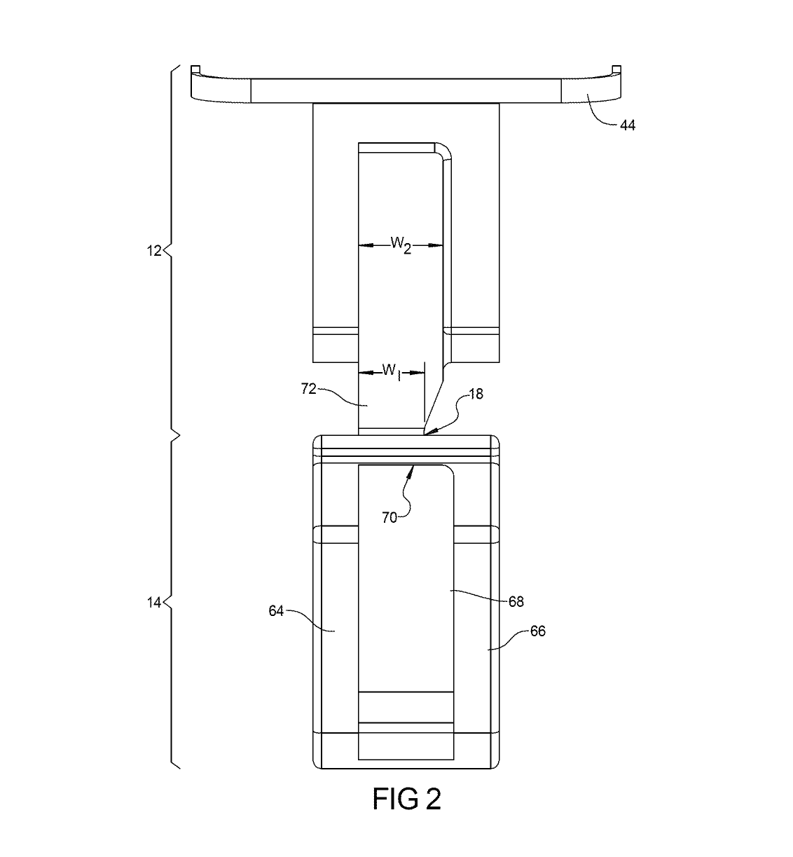

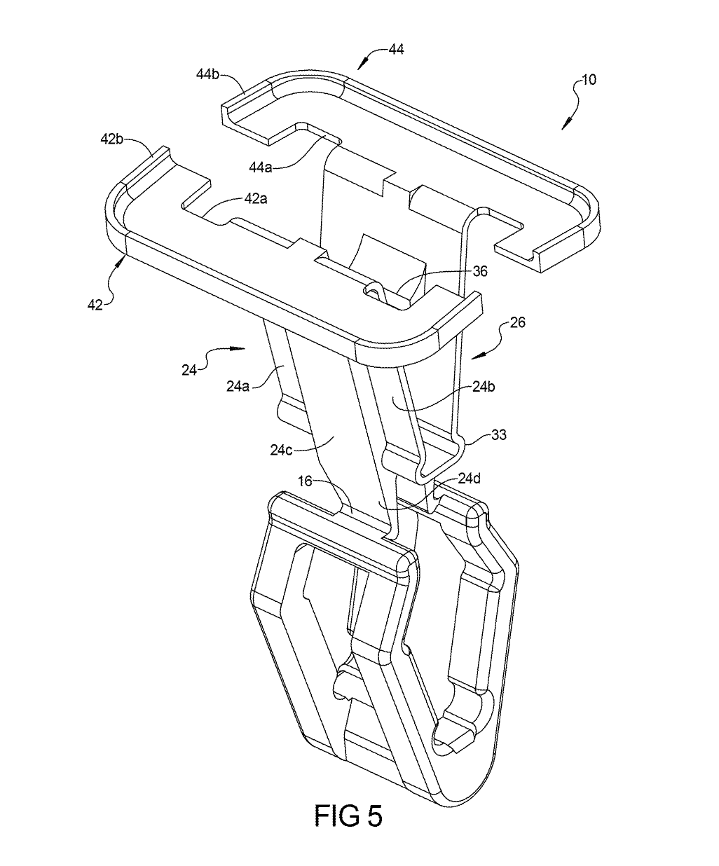

Referring to FIG. 2 and again to FIG. 1, each of the first and second tension legs 50, 52 and the first and second support legs 54, 56 are separated to define first and second leg portions 64, 66 separated by cross beam 67 defining a window 68 between the first and second leg portions 64, 66. An edge 70 of the cross beam 67 at the top of window 68 is provided as a locking feature which will be described in reference to FIG. 4. A narrow portion 72 at ends of each of the first and second legs 24, 26 is provided to reduce a length of the first and second frangible joints 16, 18, which acts to reduce the force required to fracture these joints. A first width W₁ of the narrow portion 72 is at least 20% less than a second width W₂ defining the major portion of the first and second legs 24, 26. The narrow portion 72 of each of the first and second legs 24, 26 is provided independently of a reduced wall thickness provided at the first and second frangible joints 16, 18 where the first and second feet 20, 22 join with the first and second wings 46, 48 such that a wall thickness “T₁” of the first and second frangible joints 16, 18 (shown in FIG. 4) is less than a wall thickness of either of the first and second feet 20, 22 and/or the first and second wings 46, 48.

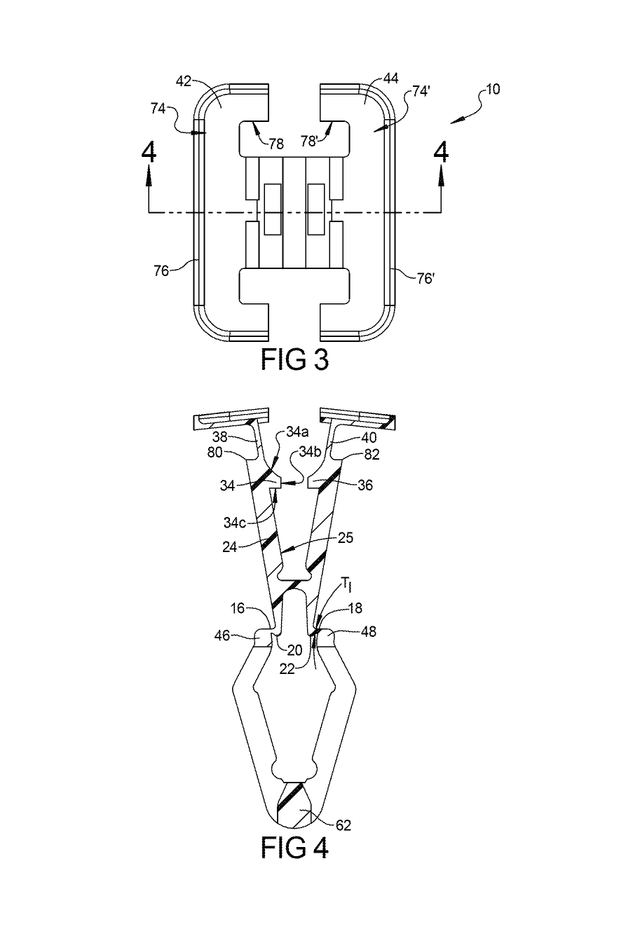

Referring to FIG. 3 and again to FIGS. 1-2, each of the first and second flanges 42, 44 include a first flat portion 74, 74′. A raised outer edge 76, 76′ defines a partial perimeter wall that is integrally connected to and extends substantially perpendicular to each flat portion 74, 74′ of the first and second flanges 42, 44. An inner edge 78, 78′ is created that provides clearance for a vehicle component part shown and described in reference to FIG. 8.

Referring to FIG. 4 and again to FIG. 3, each of the first flat portions 74, 74′ is oriented approximately perpendicular to one of the first or second connecting walls 38, 40. The second raised member 36 is substantially a mirror image of first raised member 34 and therefore the following discussion of first raised member 34 applies equally to second raised member 36. First raised member 34 includes an inwardly curving concave shaped surface 34a facing the first flange 42. A first flat inward edge 34b continues from surface 34a and faces second raised member 36. A second flat edge 34c is oriented substantially perpendicular to first flat edge 34b. A junction between second flat edge 34c and an inner face 25 of first leg 24 defines an acute angle. The frangible joints 16, 18 define a thinnest wall thickness “T₁” of the material joining first foot 20 to first reversed wing 46 and joining second foot 22 to second reversed wing 48.

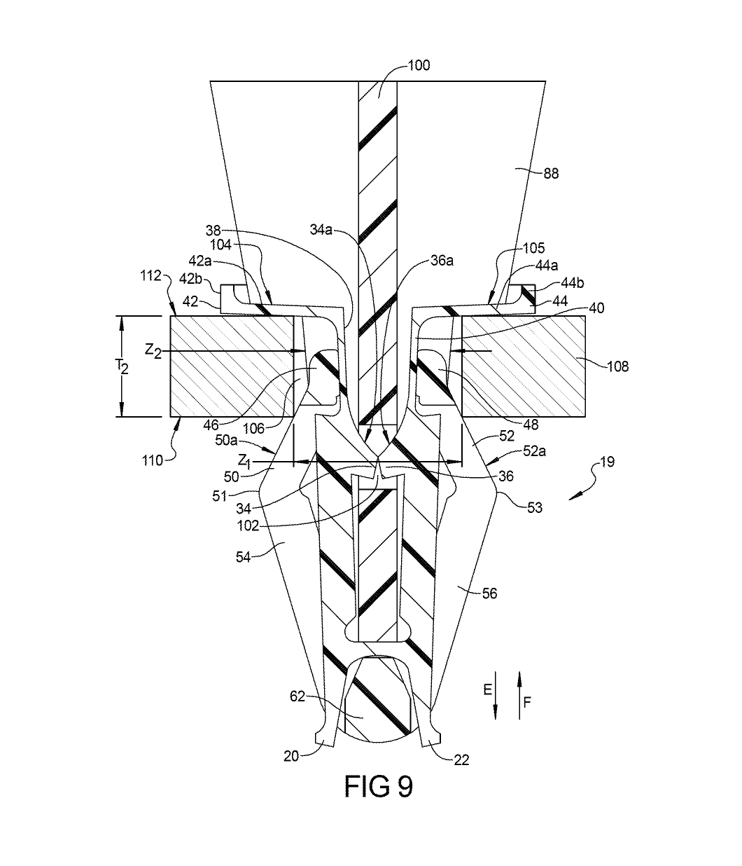

Referring to FIG. 5 and again to FIGS. 1-4, the first and second legs 24, 26 are substantially mirror images of each other, therefore the following discussion of first leg 24 applies equally to second leg 26. First leg 24 includes first and second side portions 24a, 24b which have a thinner wall thickness than a wall thickness of a center reinforcing portion 24c. An integral extending portion 24d extends downwardly from the reinforcing portion 24c beyond both first and second side portions 24a, 24b to provide for the frangible joint 16 location. The thicker wall of center reinforcing portion 24c provides integral support for the first raised member 34 (only second raised member 36 is visible in this view). Each of the first and second flanges 42, 44 further includes a membrane or web 42a, 44a and a raised outer lip 42b, 44b the functions of which are described in greater detail in reference to FIG. 9.

Referring to FIG. 6 and again to FIGS. 1-4, to create frictionally coupled two-piece joined assembly 19, after removal from the mold, a force “F” is applied in a direction “A” to the connecting bridge 28 of first portion 12 while the second portion 14 is retained. This application of force “F” causes fracture of the first and second frangible joints 16, 18 and thereafter causes the first portion 12 to move in the direction “A” such that first and second legs 24, 26 are slidably received within cavity 58 with motion continuing until connecting bridge 28 contacts body end 62. The first and second tension legs 50, 52 and the first and second support legs 54, 56 deflect outwardly away from each other as first portion 12 is received between them. The first tension leg 50 and the first support leg 54 rebound in an arc “B” and the second tension leg 52 and the second support leg 56 then rebound in an opposite arc “C” until the wing 46 contacts first connecting wall 38 and the wing 48 contacts second connecting wall 40. The first and second feet 20, 22 are positioned on opposite sides of body end 62 to help stabilize the first and second portions 12, 14. When connecting bridge 28 contacts the end wall 61 in oval-shaped cavity 60, the oval-shaped raised member 33 of first portion 12 snaps into and is frictionally retained by the oval shaped wall of oval-shaped cavity 60.

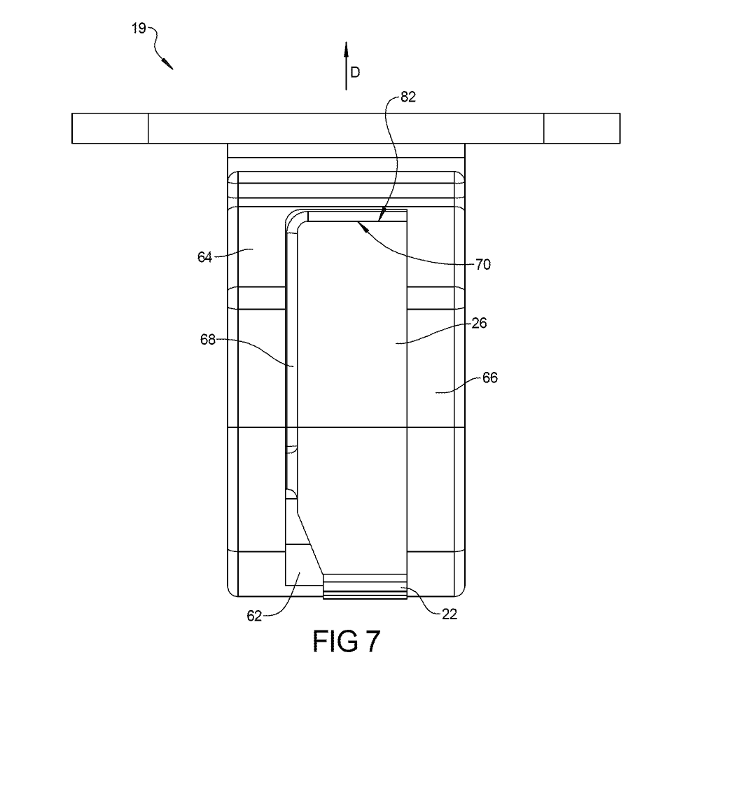

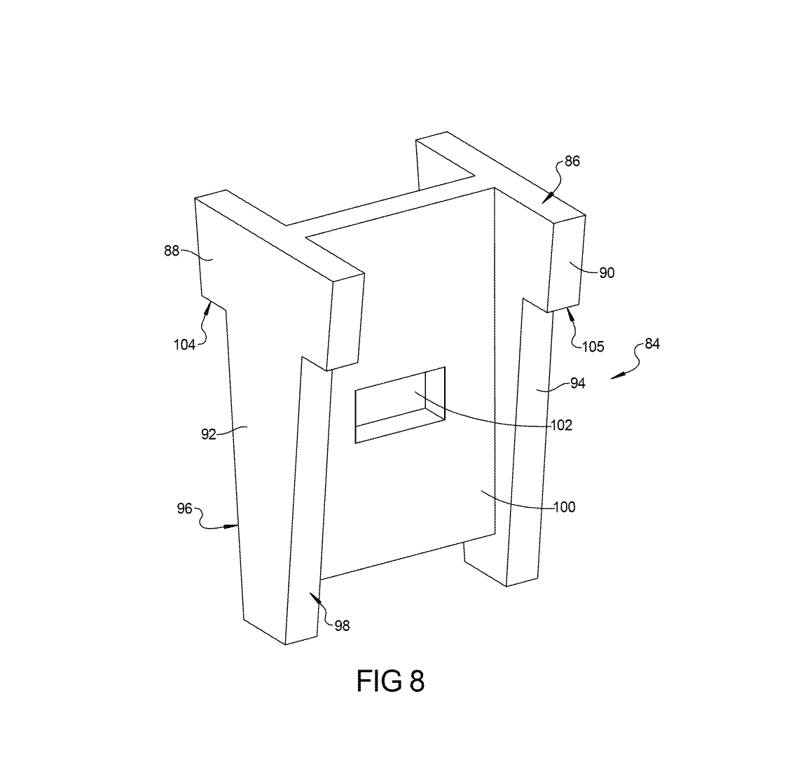

Referring to FIG. 7 and again to FIGS. 1-4, frictionally coupled two-piece joined assembly 19 is retained using a first catch member 80 (shown in FIG. 4) of first leg 24 and a second catch member 82 (shown in FIG. 4) of second leg 26 which are individually positioned below the edge 70 (shown in FIG. 2) of both windows 68 (note, only the second catch member 82 of second leg 26 is visible in this view). The first and second catch members 80, 82 prevent displacement of first portion 12 in a release direction “D”. The second leg 26 is positioned within and extending partially out of window 68 between first and second leg portions 64, 66. An extension of second foot 22 outward from body end 62 is also evident. A finished assembly defining two-piece joined assembly 19 having the first and second portions 12, 14 coupled to each other is thereby created.

Referring to FIG. 8 and again to FIG. 6, a rib tower 84 is intended to mate with two-piece joined assembly 19. Rib tower 84 can integrally extend from a component such as a trim piece (not shown) at a connecting joint 86. Rib tower 84 includes opposed and parallel first and second tower walls 88, 90. A first tapering leg 92 extends from first tower wall 88, and a second tapering leg 94 extends from second tower wall 90. Each of the first and second tapering legs 92, 94 include opposed edges 96, 98. A connecting rib 100 joins and separates the first and second tower walls 88, 90. Connecting rib 100 includes a rectangular shaped aperture 102. First and second bottom facing edges 104, 105 are also provided at a junction where the first and second tower walls 88, 90 extend outwardly past the first and second tapering legs 92, 94.

Referring to FIG. 9, and again to FIGS. 4 and 6-8, the two-piece joined assembly 19 is used by initially inserting the connecting rib 100 and first and second tapering legs 92, 94 of rib tower 84 in an installation direction “E” into a space between first and second connecting walls 38, 40 until a free end of connecting rib 100 contacts body end 62. The concave shaped surfaces 34a, 36a of the first and second raised members 34, 36 reduce a contact friction with the first and second raised members 34, 36 from the connecting rib 100 as the connecting rib 100 passes through. The first and second feet 20, 22 are oppositely positioned about and contact body end 62, which also helps to fix the orientation of and therefore prevent rocking motion between first portion 12 and second portion 14. At this time the connecting rib 100 is positioned within cavity 30 and a biasing force created by a spring effect of reversed wings 46, 48 acting to close first and second connecting walls 38, 40 will cause the first and second raised members 34, 36 to enter the aperture 102. The first and second raised members 34, 36 can contact each other, but neither extends into the aperture 102 past a centerline of the connecting rib 100. If a release force is applied, the second flat edges 34c, 36c of the first and second inner raised members 34, 36 will contact a lower inner wall of the aperture 102, thereafter preventing release in a release direction “F” of the two-piece joined assembly 19 from rib tower 84.

The assembly of the rib tower 84 and the two-piece joined assembly 19 of fastener 10 can then be inserted through a slot 106 created in a body panel 108 of a vehicle. A width Z₁ of slot 106 is less than the spacing between apexes 51, 53 therefore the first and second tension legs 50, 52 and the first and second support legs 54, 56 together inwardly deflect during passage through slot 106, and then outwardly rebound when in the installed position shown. The juncture between the first and second tension legs 50, 52 and the first and second support legs 54, 56 defines a flexing point which allows the second portion 14 to inwardly compress in the slot 106, with a subsequent outward biasing force created to help hold the first and second tension legs 50, 52 in contact with the body panel 108. In addition, the width Z₁ of slot 106 is greater than a width Z₂ of the first and second tapering legs 92, 94 passing through slot 106, therefore contact between first and second tension legs 50, 52 is prevented with the inner wall of slot 106, which prevents contact between material of the rib tower 84 and body panel 108, thereby preventing acoustic or vibration transmission.

Based on the known thickness “T₂” of body panel 108, tapering outer faces 50a, 52a of first and second tension legs 50, 52 directly contact an underside or first surface 110 of body panel 108 at an intersection of the first surface 110 and the inner wall of slot 106, while simultaneously the membranes 42a, 44a of the first and second flanges 42, 44 directly contact an upper or second surface 112 of body panel 108 to retain the two-piece joined assembly 19 and rib tower 84 in the engaged position. Contact of the bottom facing edges 104, 105 of rib tower 84 with the flat portion 74 of each of the first and second flanges 42, 44 acts as an acoustic barrier preventing noise and vibration transmission between the rib tower 84 (and therefore between the attached trim component) and the body panel 108. The raised outer lip 42b, 44b of each of the first and second flanges 42, 44 extend outward of the first and second tower walls 88, 90 of rib tower 84 which further prevents material of the rib tower 84 from contacting the body panel 108.

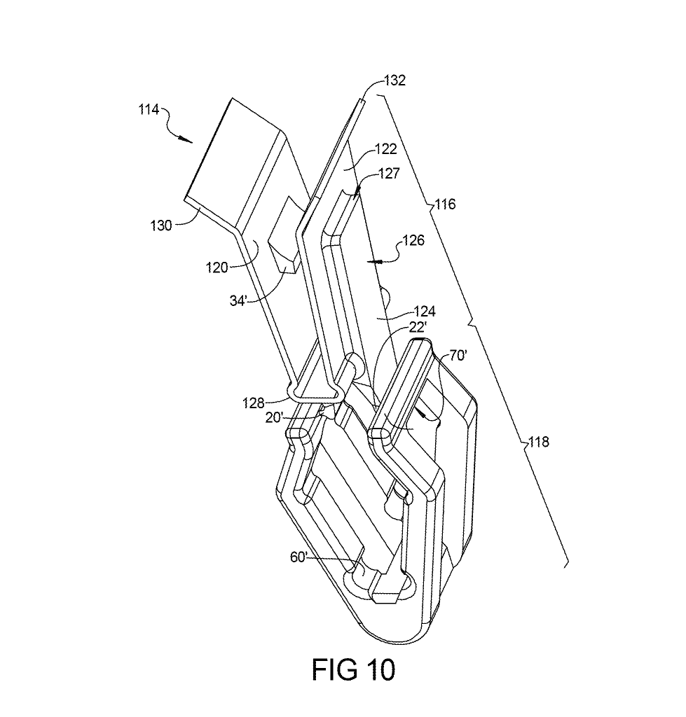

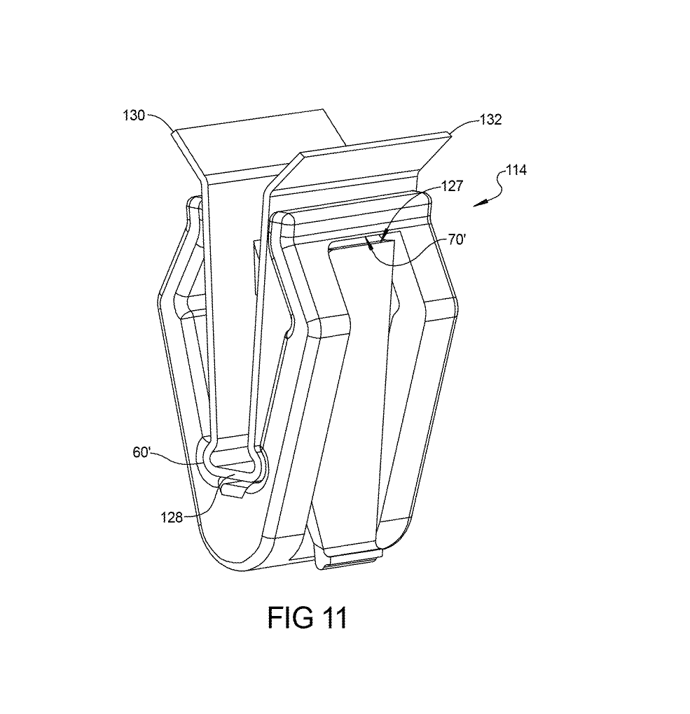

Referring to FIGS. 10 and 11, according to a further aspect a fastener 114 is modified from fastener 10 to provide a first portion 116 integrally joined to a second portion 118. Second portion 118 is similar to second portion 14 and includes the rounded cavity 60′. First portion 116 includes frangible connections at an intersection of first and second feet 20′, 22′ with second portion 118. Opposed first and second legs 120, 122 are modified from first and second legs 24, 26 to be substantially planar. A raised rectangular shaped leg portion 124 outwardly extends from each of the first and second legs 120, 122 and provides a planar surface 124. A face 127 of each of the leg portions 124 act as a retention feature in contact with the edge 70′ of second portion 118. First and second inner raised members 34′, 36′ (only first raised member 34′ is clearly visible) are provided facing each other and integrally connected to the first and second legs 120, 122 respectively. An outwardly rounded end 128 of first portion 116 is adapted to seat in the rounded cavity 60′ as shown in FIG. 11. Instead of the first and second flanges 42, 44 of fastener 10, fastener 114 includes outwardly angularly oriented first and second contact edges 130, 132. The angle of first and second contact edges 130, 132 allows fastener 114 to be used in body panels of vehicles having a wide range of thicknesses.

As further shown in FIG. 11, when fastener 114 is assembled, the outwardly rounded end 128 of first portion 116 seats in the rounded cavity 60′. The face 127 of each of the leg portions 124 contacts and acts as a retention feature in contact with the edge 70′ of second portion 118. The first and second contact edges 130, 132 are oriented to contact the inner wall of the slot created in the body panel, as well as being outwardly oriented to slidably receive the rib tower (not shown).

Fasteners of the present disclosure provide multiple advantages, including the fasteners 10, 114 having frangible joints initially coupling first and second portions in an as-molded condition that allow the first portion to be subsequently inserted into and coupled to the second portion by application of a force fracturing the frangible joints. The fasteners 10, 114 have flanges or contact edges that directly contact the vehicle body panel on one face of the body panel while the flexible legs of the fastener contact the second side of the body panel to prevent noise/vibration transmission. The fasteners 10, 114 have first portion legs where the fracture joints are initially located that are repositioned to outward facing sides of the second portion body end to stabilize the assembly of the first and second portions. The use of spring biased legs of the second portion help retain the internally directed inner raised members of the first portion.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fastener, comprising:
a first portion having first and second legs;
a second portion having opposed first and second wings defining a V-shape; and
a frictionally coupled two-piece joined assembly of the first and second body portions created when a force applied to the first portion drives the first portion into a cavity of the second portion between the first and second wings, the first portion thereafter retained by contact between a first catch member of the first leg and a second catch member of the second leg extending into a window created in each of the first and second wings and directly contacting an edge of each window.

2. The fastener of claim 1, wherein the first and second wings define an upside-down A-shape and are both of a polymeric material and are individually initially integrally coupled to one of the legs by a frangible joint in an as-molded condition of the fastener.

3. The fastener of claim 2, wherein the force is applied to a connecting bridge integrally joining the first and second legs of the first portion to drive the first portion into the cavity of the second portion between the first and second wings fractures the frangible joint at each of the first and second wings.

4. The fastener of claim 1, wherein the first portion includes first and second connecting walls integrally extending from ends of the first and second legs, the first and second connecting walls supporting first and second flanges oriented perpendicular to the first and second connecting walls.

5. The fastener of claim 1, wherein the two-piece joined assembly is adapted to be engaged in an aperture of a vehicle body panel, having the first and second flanges contacting a first surface of the body panel and the first and second wings contacting an oppositely facing second surface of the body panel such that when a trim component is connected by the two-piece joined assembly to the body panel a rib of the trim component is received between the first and second legs and a tower of the trim component contacts the first and second flanges preventing direct contact between the trim component and the body panel.

6. The fastener of claim 5:
wherein the first leg includes a first raised member and the second leg includes a second raised member; and
wherein the trim component rib includes a rib aperture having the first and second raised members received in the rib aperture acting to prevent release of the trim component from the two-piece joined assembly.

7. The fastener of claim 5, wherein a juncture between first and second tension legs and first and second support legs of the second portion defines a flexing point which allows the second portion to inwardly compress in the slot, creating a subsequent outward biasing force to help hold the first and second tension legs in contact with the body panel.

8. The fastener of claim 1, further including a narrow portion of each of the first and second legs proximate to the first and second frangible joints acting to reduce a length of the first and second frangible joints thereby reducing the force applied to the first portion necessary to fracture the first and second frangible joints.

9. The fastener of claim 8, wherein a first width W₁ of the narrow portion is at least 20% less than a second width W₂ of a major portion of the first and second legs.

10. The fastener of claim 1, wherein when the two-piece joined assembly is created, a first foot of the first leg and a second foot of the second leg are oppositely positioned about and contact a body end of the second portion, preventing rocking motion between the first and second portions.

11. A fastener, comprising:
a first portion having first and second legs defining an upside-down A-shape;
a second portion having opposed first and second wings defining a V-shape;
the first and second wings are individually initially integrally coupled to one of the legs by a frangible joint in an as-molded condition of the fastener and
a frictionally coupled two-piece joined assembly of the first and second body portions created when a force applied to the first portion drives the first portion into a cavity of the second portion between the first and second wings fracturing the frangible joint, the first portion thereafter retained together with the second portion by a first foot of the first leg and a second foot of the second leg which are oppositely positioned about and contact a body end of the second portion, preventing rocking motion between the first and second portions.

12. The fastener of claim 11, wherein each of the first and second flanges includes a raised outer lip.

13. The fastener of claim 11, further including a first catch member of the first leg and a second catch member of the second leg extending into a window created in each of the first and second wings and directly contacting an edge of each window, contact between the first and second catch members and the window of each of the first and second wings retaining the first portion within the second portion.

14. The fastener of claim 11, wherein the two-piece joined assembly is adapted to be engaged in an aperture of a vehicle body panel, having the first and second flanges contacting a first surface of the body panel and the first and second wings contacting an oppositely facing second surface of the body panel such that when a trim component is connected by the two-piece joined assembly to the body panel a rib of the trim component is received between the first and second legs and a tower of the trim component contacts the first and second flanges preventing direct contact between the trim component and the body panel.

15. The fastener of claim 14, wherein each of the first and second flanges includes a raised outer lip.

16. The fastener of claim 15, wherein the raised outer lip of each of the first and second flanges extends outward of first and second tower walls of the rib tower which further prevents material of the rib tower from contacting the body panel.

17. The fastener of claim 11, wherein the first and second portions are a polymeric material and are initially integrally joined by the frangible joint during a molding operation.

18. The fastener of claim 11, wherein the A-shape first portion defines a cavity having an oval shaped end and an end wall.

19. The fastener of claim 18, wherein the first portion includes a partial oval-shaped raised member created at the oval shaped end which corresponds to the geometry of oval shaped end.

20. The fastener of claim 19, wherein when the first portion is received in the second portion, the oval-shaped raised member of the first portion snaps into and is frictionally retained by the oval shaped wall of the oval-shaped cavity.

21. A fastener, comprising:
a first portion having first and second legs;
a second portion having opposed first and second wings;
a frictionally coupled two-piece joined assembly of the first and second body portions created when a force applied to the first portion drives the first portion into a cavity of the second portion between the first and second wings, the first portion thereafter retained by contact between a first catch member of the first leg and a second catch member of the second leg extending into a window created in each of the first and second wings and directly contacting an edge of each window; and
a first foot of the first leg and a second foot of the second leg are oppositely positioned about and contact a body end of the second portion, preventing rocking motion between the first and second portions.

22. A fastener system, comprising:
a first portion having first and second legs defining an upside-down A-shape;
a first flange integrally connected to the first leg and a second flange integrally connected to the second leg;
a second portion having opposed first and second wings defining a V-shape;
a frictionally coupled two-piece joined assembly of the first and second body portions created when a force applied to the first portion drives the first portion into a cavity of the second portion between the first and second wings, the first portion thereafter retained by contact between a first catch member of the first leg and a second catch member of the second leg individually positioned in direct contact with an edge of a window created in each of the first and second wings; and
the two-piece joined assembly adapted to be engaged in an aperture of a vehicle body panel, having the first and second flanges contacting a first surface of the body panel and the first and second wings contacting an oppositely facing second surface of the body panel such that when a trim component is connected by the two-piece joined assembly to the body panel a rib of the trim component is received between the first and second legs and a tower of the trim component contacts the first and second flanges preventing direct contact between the trim component and the body panel.

23. The fastener system of claim 22, wherein each of the first and second flanges includes a raised outer lip, the raised outer lip of each of the first and second flanges extending outward of first and second tower walls of the rib tower which further prevents material of the rib tower from contacting the body panel.

24. The fastener of claim 22, wherein when the two-piece joined assembly is created, a first foot of the first leg and a second foot of the second leg are oppositely positioned about and contact a body end of the second portion, preventing rocking motion between the first and second portions.

25. A method for forming a fastener, the method comprising the steps of:
forming a fastener first portion having first and second legs defining an upside-down A-shape;
simultaneously co-forming a fastener second portion having opposed first and second wings defining a V-shape;
initially integrally coupling each one of the first and second wings to an individual one of the legs by a frangible joint defining an as-molded condition of the fastener; and
applying a force to the first portion thereby fracturing the frangible joint;
continuing application of the force to drive the first portion into the cavity of the second portion between the first and second wings; and
retaining the first portion together with the second portion by positioning a first catch member of the first leg and a second catch member of the second leg individually in direct contact with an edge of a window created in each of the first and second wings to create a frictionally coupled two-piece joined assembly of the first and second body portions.
